(19) United States
(12) Patent Application Publication
(10) Pub. No.: US 2011/0294910 A1
(43) Pub. Date: Dec. 1, 2011

(54) EXPANDABLE PELLETIZED POLYAMIDE MATERIAL

(75) Inventors: Olaf Kriha, Neustadt (DE); Klaus Hahn, Kirchheim (DE); Philippe Desbois, Edingen-Neckarhausen (DE); Volker Warzelhan, Weisenheim am Berg (DE); Holger Ruckdäschel, St. Martin (DE); Maximilian Hofmann, Mannheim (DE); Christian Exner, Lorrach (DE); Roland Hingmann, Ladenburg (DE)

(73) Assignee: BASF SE, Ludwigshafen (DE)

(21) Appl. No.: 13/095,044

(22) Filed: Apr. 27, 2011

Related U.S. Application Data
(60) Provisional application No. 61/328,261, filed on Apr. 27, 2010.

(51) Int. Cl. C08L 77/00; B32B 3/02; C08J 9/18

(52) U.S. Cl. 521/59

(57) ABSTRACT

An expandable pelletized material comprising
A) a polymer matrix composed of
   A1) at least 55% by weight of polyamide (based on the entirety of components A1) and A2)) with a crystallinity of up to 30% and if appropriate a melting point in the range from 100 to 340° C. and a glass transition temperature in the range from 0 to 150° C., and
   A2) from 0 to 45% by weight of one or more thermoplastic polymers that differ from component A1);
B) a physical blowing agent composition, and
C) optionally further additives,
   is suitable for producing a moldable foam for use in the automobile industry, airline industry, construction industry, packaging industry, or sports and leisure industry, or in the transport sector, and/or in engineering.

The invention relates to an expandable pelletized material based on polyamide, to moldable foams and foam moldings obtainable therefrom, to processes for their production, and also to their use in the automobile industry, airline industry, construction industry, or packaging industry, and/or in the transport sector.

Polyamide-based foams have a comparatively small application sector, because of technical problems during processing, and because their densities are usually higher than those of polystyrene foams or polyurethane foams.

Low-density polyamide foams are known by way of example from U.S. Pat. No. 4,022,719. That document uses one or more specific lactams, a basic alkali-metal salt of a lactam as catalyst, an alkyl isocyanate activator, and a blowing agent.

US-A 2006/0167124 describes an expandable polyamide-based pelletized material which comprises, alongside a polyamide, at least one compound having an isocyanate group, and at least one compound having a carboxylic acid group.

WO-A 2010/000572 discloses self-foaming polyamides which comprise, alongside a polyamide, a copolymer which liberates CO₂ on heating and thus generates the polyamide foam.

Despite these advances, there continues to be much demand for expandable pelletized polyamide materials and polyamide foams which have not only low density but also good processability. A feature of moldable foams here is a high degree of freedom in the shaping of the components made from the foams; the use of moldable foams is also very effective in conserving resources, since the density of the foam can be adjusted during the prefoaming process, and with this it is also possible to adjust the amount of raw material required and the properties of the foam. These moldable foams can then be foamed to give slabs or complex moldings, in a single operation.

It has been found that use of a polyamide in which crystallinity, glass transition temperature, and melting point lie within a certain range can give an expandable pelletized polyamide material which can easily be expanded to give low-density foams, by using steam.

The invention therefore provides an expandable pelletized material comprising

A) a polymer matrix composed of
A1) at least 55% by weight of polyamide (based on the entirety of components A1) and A2)) with a crystallinity of up to 30% and if appropriate a melting point in the range from 100 to 340° C. and a glass transition temperature in the range from 0 to 150° C., and
A2) from 0 to 45% by weight of one or more thermoplastic polymers that differ from component A1);
   B) a physical blowing agent composition, and
   C) optionally further additives.

The invention further provides a process for producing the pelletized material of the invention, comprising the following steps:
a) provision of the polyamide A1) or of its precursors and if appropriate of polymer component A2) in a molten state,
b) mixing to incorporate physical blowing agent component B) and if appropriate one or more additives C) into the melt,
c) extrusion, and
d) underwater pelletization of the melt comprising blowing agent.

The invention further provides a moldable polyamide foam obtainable via prefoaming of the pelletized material of the invention, and also provides foam moldings obtainable via expansion and compression of the moldable polyamide foam.

The invention further provides the use of the moldable polyamide foam of the invention in the automobile industry, airline industry, construction industry, or packaging industry, and/or in the transport sector.

The pelletized materials of the invention, i.e. the expandable polyamide-based pelletized materials described above, and preferred embodiments thereof, can be processed to give low-density foam moldings. The small amount of organic blowing agent provides environmental and economic advantages; furthermore, the expandable pelletized polyamide material has very good shelf life. Further advantages are very low heat-shrinkage, advantageous fire performance without flame retardant, good solvent resistance, good metal adhesion, high heat resistance, and also good adhesion and stability when epoxy adhesives are used.

The pelletized material of the invention comprises a polyamide A1) with a crystallinity of up to 30%, with a glass transition temperature in the range from 0 to 150° C. and if appropriate a melting point in the range from 100 to 340° C.

In the invention, the term “polyamide” means thermoplastics the repeat units of which are characterized by an amide group. The term comprises not only homopolymers, i.e. polyamides composed of one acid component and of one amine component, or of one lactam component, but also copolymers, i.e. polyamides composed of at least two acid components and/or of two amine components, and/or lactam components.

The polyamide A1) of the invention is a homo- or copolyamide, or a mixture made of a plurality of homo- and/or copolyamides, with the proviso that the mixture complies with the conditions mentioned in respect of semicrystallinity, glass transition temperature and if appropriate melting point.

In the invention, the term “semicrystalline” means polyamides with domains that are to some extent crystalline, where these—in the region of said crystalline domains—have not only a glass transition temperature but also a melting point. Polyamide component A1) of the invention can also be amorphous, i.e. have 0% crystallinity. In that case, component A1) has no melting point. The expression “if appropriate a melting point in the range from 100° C. to 340° C.” therefore means that if component A1) is not amorphous it has an appropriate melting point in its crystalline regions.

Crystallinity is preferably in the range from 1 to 25%, particularly preferably from 3 to 20%.

In the case of semicrystalline polymers, melting point is in the range from 100 to 340° C., preferably in the range from 130 to 300° C., particularly preferably from 150 to 280° C.

Glass transition temperature is preferably in the range from 15 to 130° C., particularly preferably from 40 to 120° C.

Preference is therefore given to polyamides A1) with a crystallinity in the range from 1 to 25%, with a melting point in the range from 130 to 300° C., and with a glass transition temperature in the range from 15 to 130° C.

Preference is further given to polyamides A1) with a crystallinity in the range from 1 to 25%, with a melting point in the range from 100 to 340° C., and with a glass transition temperature in the range from 0 to 150° C.

Preference is further given to polyamides A1) with a crystallinity in the range from 1 to 25%, with a melting point in the range from 130 to 300° C., and with a glass transition temperature in the range from 0 to 150° C.

Preference is further given to polyamides A1) with a crystallinity in the range from 1 to 25%, with a melting point in the range from 100 to 340° C., and with a glass transition temperature in the range from 15 to 130° C.

Preference is further given to polyamides A1) with a crystallinity up to 30%, if appropriate with a melting point in the range from 130 to 300° C., and with a glass transition temperature in the range from 15 to 130° C.

Preference is further given to polyamides A1) with a crystallinity up to 30%, if appropriate with a melting point in the range from 100 to 340° C., and with a glass transition temperature in the range from 15 to 130° C.

Preference is further given to polyamides A1) with a crystallinity up to 30%, if appropriate with a melting point in the range from 130 to 300° C., and with a glass transition temperature in the range from 0 to 150° C.

Particular preference is given to polyamides A1) with a crystallinity in the range from 3 to 20%, with a melting point in the range from 150 to 280° C., and with a glass transition temperature in the range from 40 to 120° C.

Particular preference is further given to polyamides A1) with a crystallinity in the range from 3 to 20%, with a melting point in the range from 150 to 280° C., and with a glass transition temperature in the range from 0 to 150° C.

Particular preference is further given to polyamides A1) with a crystallinity in the range from 3 to 20%, with a melting point in the range from 150 to 280° C., and with a glass transition temperature in the range from 15 to 130° C.

Particular preference is further given to polyamides A1) with a crystallinity in the range from 3 to 20%, with a melting point in the range from 150 to 280° C., and with a glass transition temperature in the range from 0 to 150° C.

Particular preference is further given to polyamides A1) with a crystallinity in the range from 3 to 20%, with a melting point in the range from 130 to 300° C., and with a glass transition temperature in the range from 40 to 120° C.

Particular preference is further given to polyamides A1) with a crystallinity in the range from 3 to 20%, with a melting point in the range from 130 to 300° C., and with a glass transition temperature in the range from 15 to 130° C.

Particular preference is further given to polyamides A1) with a crystallinity in the range from 3 to 20%, with a melting point in the range from 130 to 300° C., and with a glass transition temperature in the range from 0 to 150° C.

Particular preference is further given to polyamides A1) with a crystallinity in the range from 3 to 20%, with a melting point in the range from 100 to 340° C., and with a glass transition temperature in the range from 40 to 120° C.

Particular preference is further given to polyamides A1) with a crystallinity in the range from 3 to 20%, with a melting point in the range from 100 to 340° C., and with a glass transition temperature in the range from 15 to 130° C.

Particular preference is further given to polyamides A1) with a crystallinity in the range from 3 to 20%, with a melting point in the range from 100 to 340° C., and with a glass transition temperature in the range from 0 to 150° C.

Particular preference is further given to polyamides A1) with a crystallinity in the range from 2 to 25%, with a melting point in the range from 150 to 280° C., and with a glass transition temperature in the range from 40 to 120° C.

Particular preference is further given to polyamides A1) with a crystallinity in the range from 2 to 25%, with a melting point in the range from 150 to 280° C., and with a glass transition temperature in the range from 15 to 130° C.

Particular preference is further given to polyamides A1) with a crystallinity in the range from 2 to 25%, with a melting point in the range from 150 to 280° C., and with a glass transition temperature in the range from 0 to 110° C.

Particular preference is further given to polyamides A1) with a crystallinity up to 30%, if appropriate with a melting point in the range from 150 to 280° C., and with a glass transition temperature in the range from 40 to 120° C.

Particular preference is further given to polyamides A) with a crystallinity up to 30%, if appropriate with a melting point in the range from 150 to 280° C., and with a glass transition temperature in the range from 15 to 130° C.

Particular preference is further given to polyamides A1) with a crystallinity up to 30%, if appropriate with a melting point in the range from 150 to 280° C., and with a glass transition temperature in the range from 0 to 150° C.

Particular preference is further given to polyamides A1) with a crystallinity in the range from 2 to 25%, with a melting point in the range from 150 to 280° C., and with a glass transition temperature in the range from 40 to 120° C.

Particular preference is further given to polyamides A1) with a crystallinity in the range from 2 to 25%, with a melting point in the range from 100 to 340° C., and with a glass transition temperature in the range from 40 to 120° C.

Particular preference is further given to polyamides A1) with a crystallinity up to 30%, if appropriate with a melting point in the range from 150 to 280° C., and with a glass transition temperature in the range from 40 to 120° C.

Particular preference is further given to polyamides A1) with a crystallinity up to 30%, if appropriate with a melting point in the range from 100 to 340° C., and with a glass transition temperature in the range from 40 to 120° C.

In the invention, crystallinity is determined with the aid of dynamic differential calorimetry (DSC, differential scanning calorimetry) via integration of the melt signal, i.e. 100% crystallinity corresponds to 230 J/g (Journal of Polymer Science Part B Polymer Physics 35 (1997) 2219-2231). In the invention, the measurement is made in accordance with ISO 11357-7.

In the invention, melting point is determined to ISO 11357-3 by using rates of 20 K/min for heating and cooling.

In the invention, glass transition temperature is determined to ISO 11357-2 by using rates of 20 K/min for heating and cooling.

Polyamides A1) that can be used are known types of homo- and/or copolyamide where these have the required property profile; these are to some extent commercially available.

Another possibility is to use an appropriate mixture of various monomeric acid components and/or of various amine components, and also, for example, underwater pelletization, to produce copolyamides which have the required property profile. By way of example, it is possible to react a mixture of acid monomers and amine monomers (or lactams) which have excessive crystallinity in the form of homopolyamides, e.g. polycaprolactam (PA 6), with other monomeric components which in the form of homopolyamide form amorphous or very-low-crystallinity structures, e.g. polyisophthalic acid (PA 6I) to give a copolyamide of the invention.

Other materials suitable as polyamide A1) are various copolyamides based on more than two monomers, examples being AB/X, AB/X/Y, X/Y/Z, A₁B₁/A₂B₂, A₁B₁/A₂B₂/A₃B₃, A₁B₁/A₂B₂/X, where

A, A₁, A₂, A₃ are identical or different, being C₂-C₁₈-diamine,
B, B₁, B₂, B₃ are identical or different, being C₂-C₁₈-diacid and
X, Y, and Z are identical or different, being C₄-C₁₄-lactam.

In another, preferred variant, the polyamide A1) used in the invention is a copolyamide, and is produced via transamidation of appropriate polyamides. Any of the known transamidation methods is suitable for this purpose, examples being described in Kunststoff Handbuch, 3/4, Polyamide 2-5, [Plastics Handbook, 3/4, Polyamides 2-5] ISBN 3-446-16486-3.

Particular preference is given to reactive mixing (blending) of the respective polyamides, in particular immediately prior to impregnation of the melt with the blowing agent component.

Particularly suitable materials for this variant are mixtures made of various semicrystalline polyamides or made of semicrystalline and amorphous polyamides, where these are reacted via transamidation in the melt to give the (co)polyamides A1) used in the invention.

Unless otherwise stated, the terminology used for the types of polyamide (PA) is in accordance with ISO 1874-1. The division into semicrystalline or amorphous types is in accordance with the conventional division used in the literature.

Suitable semicrystalline precursors of the polyamide A1) are homopolyamides such as polycaprolactam (PA6), polybutyleneadipamide (PA 46), polyhexamethyleneadipamide (PA 66), polyhexamethylenesebacamide (PA 610), polyhexamethylenedodecanamide (PA 612), poly-11-aminoundecanamide (PA 11), polylaurolactam (PA 12), poly-m-xylyleneadipamide (PAMXD 6), polypentamethylenesebacamide (PA 510), 6T/X (X=lactam), 6T/6I, 6T/6I/XY, 6T/XT (X=straight-chain or branched C₄-C₁₈-diamine), XT (X=C₄-C₁₈-diamine), mixtures of two lactams, such as 6.12. PA PACM 12 (PACM=p-diaminodicyclohexylmethane) and PA MPMD 6 (MPMD=2-methylpentamethylendiamine), PA MPMD T, and also PA MPMD 12. Preferred semicrystalline precursors of the polyamide A1) are PA 6, PA 66, PA 510, and PA 6/66, and particular preference is given to PA 6.

Materials which are suitable amorphous precursors of the polyamide A1) are homopolyamides such as polyhexamethylenisophthalamide (PA 6I), PA 6I/6T, PA 6-3-T (polyamide made of terephthalic acid and of a mixture of 2,2,4- and 2,4,4-trimethylhexamethylendiamine). Preference is given to PA PACM 12 (PACM=p-diaminodicyclohexylmethane) and PA MACM 12 (MACM=3,3-dimethyl-p-diaminodicyclohexylmethane). Particular preference is given to a copolymer made of caprolactam, hexamethylendiamine, isophthalic acid and terephthalic acid (PA6I/6T) (e.g. Grivory G16, EMS-Chemie GmbH, Groβ-Umstadt, Germany), nylon-6/6,6/PACM, 6 (e.g. Ultramid 1C, BASF SE, Ludwigshafen, Germany, nylon-6,I (e.g. Durethan T40, Lanxess AG, Leverkusen, Germany).

PA 6I is preferred as amorphous precursor of the polyamide A1).

Preferred mixtures for generating the polyamide A1) are composed of PA 6, PA 6/66 and/or PA 610 in a mixture with PA 6I. Particular preference is given to the mixture of PA 6 and PA 6I.

The polyamides mentioned are known and commercially available, an example being PA 6 with the name Ultramid® B from BASF SE, Ludwigshafen, Germany.

The intrinsic viscosity of the polyamides used in the invention is generally from 30 to 350 ml/g, preferably from 40 to 200 ml/g, determined in 0.5% strength by weight solution in 96% strength by sulfuric acid at 25° C. to ISO 307.

The following ratios by weight have proven successful in particular for the mixture of PA 6 and PA 6I: 1: from 0.25 to 3, preferably 1: from 0.4 to 2,5, particularly preferably 1: from 0.5 to 2.

In the light of the above information, in particular relating to the types of polyamide, the person skilled in the art can easily use routine experiments where appropriate to obtain various suitable polyamide components A1), in addition to those specifically described.

The invention therefore also provides an expandable pelletized material of the invention, where component A1) comprises two or more polyamides from the group of polycaprolactam (PA6), polybutyleneadipamide (PA 46), polyhexamethyleneadipamide (PA 66), polyhexamethylenesebacamide (PA 610), polyhexamethylenedodecanamide (PA 612), poly-11-aminoundecanamide (PA 11), polylaurolactam (PA 12), poly-m-xylyleneadipamide (PAMXD 6), polypentamethylenesebacamide (PA 510), 6T/X (X=lactam), 6T/6I, 6T/6I/XY, 6T/XT (X=straight-chain or branched C₄-C₁₈-diamine), XT (X=C₄-C₁₈-diamine), 6.12. PA PACM 12 (PACM=p-diaminodicyclohexylmethane), PA MACM 12 (MACM=3,3-dimethyl-p-diaminodicyclohexylmethane), PA MPMD 6 (MPMD=2-methylpentamethylenediamine), PA MPMD T, PA MPMD 12, polyhexamethyleneisophthalamide (PA 6I), PA 6I/6T, PA 6-3-T (polyamide made of terephthalic acid, mixtures made of 2,2,4- and 2,4,4-trimethylhexamethylenediamine) and their transamidation products. It is preferable that component A1) comprises PA6, PA 6/66 and/or PA 610 in a mixture with PA 6I, and/or comprises their transamidation products.

In one preferred embodiment, the polymer matrix A) consists of polyamide component A1), i.e. (A2)=0%.

The pelletized material of the invention comprises, as component A2) (based on the entirety of components A1) and A2)) up to 45% by weight of one or more thermoplastic polymers that differ from component A1).

It is preferable that component A2) is not miscible with polyamide component A1), thus causing formation of domains of components A1) and A2). If the pelletized material of the invention comprises both components, it is possible to use measurements on domains of polyamide component A1) to determine the inventive properties of the polyamide component. It is preferable that component A2) does not involve polycondensates.

In one preferred embodiment, the pelletized material of the invention comprises (based on the entirety of components A1) and A2)) from 0.1 to 20% by weight, particularly from 0.4 to 15% by weight, in particular from 1 to 12% by weight, of one or more thermoplastic polymers A2), in particular of one or more styrene polymers (see below).

Inert polymers which exhibit higher solubility than the polyamide A1) for the blowing agent, and which therefore serve as blowing agent reservoir, are preferred as component A2). Addition of this type of component A2) can produce foams with low density, preferably in the range around 25 to 100 g/l.

Preference is therefore given to the following materials as component A2): styrene polymers, polyacrylates, polyolefins, polysulfones, polyether sulfones, polyphenylene ethers and blends made of two or more of said polymers.

Particular preference is given to the following materials as component A2): styrene polymers and/or their blends with polyphenylene ether.

In the invention, the term styrene polymer comprises polymers based on styrene, alpha-methyl styrene, or a mixture of styrene and alpha-methyl styrene; this applies by analogy to the styrene content in SAN, AMSAN, ABS, ASA, MBS, and MABS (see below).

Preferred styrene polymers are: glassclear polystyrene (GPPS), impact-resistance polystyrene (HIPS), anionically polymerized polystyrene or impact-resistance polystyrene (A-IPS), styrene-alpha-methyl styrene copolymers, acrylonitrile-butadiene-styrene polymers (ABS), styrene-acrylonitrile copolymers (SAN), acrylonitrile-alpha-methylstyrene copolymers (AMSAN), acrylonitrile-styrene-acrylate (ASA), methacrylate-butadiene-styrene (MBS), methyl methacrylate-acrylonitrile-butadiene-styrene (MABS) polymers or a mixture thereof or with polyphenylene ether (PPE).

It is also possible to admix polymer recyclates of the thermoplastic polymers mentioned, in particular styrene polymers and expandable styrene polymers (EPS), in amounts which do not substantially impair their properties, generally in amounts of at most 50% by weight, in particular in amounts of from 1 to 20% by weight (based on component A2)).

To produce the pellets of the invention, a melt of component A1) and, if appropriate, A2) is impregnated with blowing agent component B).

A suitable blowing agent component B) is one or more physical blowing agents, in particular organic blowing agents, e.g. aliphatic hydrocarbons having from 2 to 7 carbon atoms, alcohols, ketones, ethers, and halogenated hydrocarbons, and/or CO₂. Preference is given to use of isopentane, n-pentane, neopentane, isobutane, n-butane, ethanol and isopropanol, and it is particularly preferable to use isopentane, n-pentane and neopentane, or else a mixture of two or more of said isomers, e.g. a mixture made of n- and isopentane. Preference is also given to mixtures made of at least two physical blowing agents. The polymer melt comprising blowing agent generally comprises a total proportion of from 0.01 to 7% by weight, preferably from 0.04 to 1.0% by weight, particularly preferably from 0.06 to 0.2% by weight, based on the polymer melt comprising blowing agent, of homogeneously distributed blowing agent component.

To improve foamability, water can advantageously be introduced into the polymer matrix. Water can way of example be added directly by way of the use of a starting material comprising water, or by way of addition to the polymer melt, or by way of addition during or after pelletization. It is preferable that water is added directly to the molten polymer matrix. In terms of location and time, the addition of the water can take place prior to, together with, or after the feed of the blowing agents. Homogeneous distribution of the water can be achieved by means of dynamic or static mixers. A sufficient amount of water is generally from 0.1 to 10% by weight, preferably from 0.3 to 8% by weight, particularly preferably from 0.5 to 4% by weight, based on the entirety of components A1) and A2).

The bulk density of the polyamide-based pellets of the invention is generally up to 900 g/l, preferably in the range from 400 to 800 g/l, particularly preferably in the range from 500 to 700 g/l. When fillers are used, bulk densities in the range above 900 g/l can arise, depending on the nature and amount of the filler.

Further additives and auxiliaries can be added, alongside the blowing agent component and water. Preference is given here to any auxiliaries and additives that are already comprised in the polymer composition, and by way of example talc can be used as nucleating aid.

To produce the pelletized material of the invention and the moldable foam obtained therefrom, the blowing agent is incorporated by mixing directly into the polymer melt at elevated pressures, and/or a polymer material previously impregnated with the blowing agent is melted. A possible process comprises the stages a) production of melt, b) introduction and mixing of the blowing agents, c) if appropriate cooling, d) conveying, e) pelletization, and f) expansion. Each of the stages a) to e) can be carried out by using the apparatus or apparatus combinations that are known for plastics processing. The polymer melt can be taken directly from a polymerization reactor, or can be produced directly in the mixing extruder or in a separate plasticating extruder by melting of pelletized polymer material. Static mixers or dynamic mixers are suitable for mixing to incorporate the blowing agents, examples being extruders. The melt can if appropriate be cooled in order to adjust to the desired melt temperature. The mixing assemblies used are suitable equipment for this purpose, as also are separate coolers or heat exchangers. The pelletization process advantageously takes place via pressurized underwater pelletization. The result is complete or at least partial suppression of any expansion of the melt comprising blowing agent during discharge from the die. The increased pressure for the pelletization dies can be achieved by using the mixing assembly (extruder) per se or by using an additional melt assembly that increases pressure. It is preferable to use a gear pump. Non-restricting examples of apparatus arrangements suitable for carrying out the process are:

a) polymerization reactor-static mixer/cooler-gear pump-pelletizer
b) polymerization reactor-melt extruder-gear pump-pelletizer
c) extruder-static mixer-pelletizer
d) extruder-static mixer-gear pump-pelletizer
e) extruder-pelletizer
f) extruder-static mixer-gear pump-pelletizer
g) extruder-gear pump-static mixer/heat exchanger-gear pump-pelletizer
h) extruder-static mixer-gear pump-static mixer/heat exchanger-gear pump-pelletizer.

The arrangement can moreover have one or more ancillary extruders or ancillary feeds for introduction of further polymers and additives, e.g. of solids or of heat-sensitive additional substances. Liquid additives can also be injected at any point within the process, preferably in the region of the static and dynamic mixing assemblies.

The temperature at which the polymer melt comprising blowing agent is conveyed through the die plate is generally in the range from 120 to 400° C., preferably from 160 to 350° C., particularly preferably in the range from 170 to 280° C.

The die plate is heated at least to the crystallization temperature of the polymer melt comprising blowing agent, in order to inhibit deposition of polymer in the dies and to provide problem-free pelletization. It is preferable that the temperature of the die plate is in the range from 10 to 200° C., particularly from 10 to 120° C., above the crystallization point of the polymer melt comprising blowing agent. The water temperature is preferably 10-90, more preferred 20-80, in particular 40-70° C.

In order to obtain marketable sizes of pelletized material, the diameter (D) of the die holes at the exit from the die should be in the range from 0.2 to 2.0 mm, preferably in the range from 0.3 to 1.5 mm, particularly preferably in the range from 0.3 to 1.0 mm. The sizes of pelletized material can thus be adjusted specifically to below 2.5 mm, in particular to the range from 0.4 to 1.5 mm, even after die swell.

Particular preference is given to a process comprising the following steps for producing a pelletized material of the invention:
a) production or provision of a melt of polymer components A1) and if appropriate A2),
b) mixing to incorporate at least one blowing agent component and if appropriate additives, such as water or talc, into the polymer melt by static or dynamic mixer at a temperature of at least 150° C.,
c) thermal homogenization and if appropriate cooling of the blowing-agent and polymer melt to a temperature of at least 120° C.,
d) discharge through a die plate with holes of which the diameter at the discharge from the die is at most 1.5 mm,
e) underwater pelletization of the melt comprising blowing agent directly behind the die plate at a pressure in the range from 1 to 20 bar, preferably 5-20 bar, e.g. 5-10 bar or 15-20 bar.
f) prefoaming of the resultant pelletized material to give a moldable PA foam.

Step (f) of the process of the invention is usually carried out with chronological separation from steps (a) to (e), for example at user's premises.

As an alternative, it is also possible that the polymer(s) is/are treated with blowing agent in the non-molten state, for example under pressure in an autoclave. For this, by way of example, polymer particles are used as initial charge in an autoclave and impregnated or saturated with the physical blowing agent (e.g. with an organic blowing agent, such as pentane, CO₂, N₂, or air). After depressurization of the autoclave, the impregnated polymer particles are heated for the preexpansion process.

The invention also provides an expandable pelletized material of the invention, obtainable by
a) provision of a mixture comprising two or more polyamides from the group of polycaprolactam (PA6), polybutyleneadipamide (PA 46), polyhexamethyleneadipamide (PA 66), polyhexamethylenesebacamide (PA 610), polyhexamethylenedodecanamide (PA 612), poly-1′-aminoundecanamide (PA 11), polylaurolactam (PA 12), poly-m-xylyleneadipamide (PAMXD 6), polypentamethylenesebacamide (PA 510), 6T/X (X=lactam), 6T/6I, 6T/6I/XY, 6T/XT (X=straight-chain or branched C₄-C₁₈-diamine), XT (X=C₄-C₁₈-diamine), 6.12. PA PACM 12 (PACM=p-diaminodicyclohexylmethane), PA MACM 12 (MACM=3,3-dimethyl-p-diaminodicyclohexylmethane), PA MPMD 6 (MPMD=2-methylpentamethylenediamine), PA MPMD T, PA MPMD 12, polyhexamethyleneisophthalamide (PA 6I), PA 6I/6T, PA 6-3-T (polyamide made of terephthalic acid, mixtures made of 2,2,4- and 2,4,4-trimethylhexamethylenediamine) and their transamidation products,
b) mixing to incorporate physical blowing agent component B) and if appropriate one or more additives C) into the melt,
c) extrusion, and
d) underwater pelletization of the melt comprising blowing agent.

The pelletized materials of the invention can be prefoamed in a first step by means of hot air or steam in what are known as prefoamers to give the foam particles of the invention with a density in the range from 25 to 300 g/l, in particular from 60 to 200 g/l, and in a second step they can be fused in a closed mold to give foam moldings (made of moldable foam). For this, the prefoamed particles are introduced into molds which do not give a gas-tight seal, and are treated with steam (for example at from 1.8 to 3.2 bar). The moldings can be removed after cooling.

The pelletized materials of the invention can comprise, based on the polymer matrix, from 0 to 50% by weight, in particular up to 40% by weight, preferably up to 30% by weight, of further additives C).

In order to stabilize the extrusion procedure, the pelletized material of the invention can comprise compounds which bring about an increase in molecular weight, examples being chain extenders and/or branching agents and/or crosslinking agents. Examples are amines, carboxy compounds, carbodiimides, oxazolines, epoxy-functionalized compounds and compounds comprising maleic anhydride groups, where these are used in the form of low-molecular-weight compounds and/or of functionalized polymers, for example based on styrene or on acrylate. Examples of suitable compounds are those marketed with trademark Joncryl® ADR by BASF SE.

Examples of crosslinking agents that can be added are water-soluble homopolymers based on acrylic acid, for example those obtainable with trademark Sokalan® PA from BASF SE.

The pelletized materials of the invention can comprise, as component C), from 0 to 3% by weight, preferably from 0.04 to 3% by weight, with preference from 0.05 to 1.5% by weight, and in particular from 0.1 to 1% by weight, of a lubricant.

Preference is given to the Al, alkali metal, or alkaline earth metal salts, or esters or amides of fatty acids having from 10 to 44 carbon atoms, preferably having from 14 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol or n-octanol, stearyl alcohol, ethylene glycol, propylene glycol, neopentyl glycol, pentaerythritol, preference being given to glycerol and pentaerythritol.

The aliphatic amines can be mono-basic to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The inventive pelletized materials can comprise, as other components C), heat stabilizers or antioxidants, or a mixture of these, selected from the group of the copper compounds, sterically hindered phenols, sterically hindered aliphatic amines, and/or aromatic amines.

The inventive pelletized materials optionally comprise from 0.01 to 3% by weight, preferably from 0.07 to 1.5% by weight, and in particular from 0.05 to 1% by weight, of copper compounds, preferably in the form of Cu(I) halide, in particular in a mixture with an alkali metal halide, preferably KI, in particular in the ratio 1:4, or of a sterically hindered phenol or of an amine stabilizer, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising polyamide, and comprising a salt of monovalent copper, and comprising an alkali metal halide in the form of a solid, homogeneous solution is added to the polymer component. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular nylon-6, nylon-6,6, and nylon-6,I.

A general overview of plasticizers suitable for polyamides can be found in Gächter/Müller, Kunststoffadditive [Plastics additives], C. Hanser Verlag, 2nd edition, p. 296.

Examples of conventional compounds suitable as plasticizers are esters of p-hydroxybenzoic acid having from 2 to 12 carbon atoms in the alcohol component, and amides of arylsulfonic acids having from 2 to 12 carbon atoms in the amine component, and preferably amides of benzenesulfonic acid.

Plasticizers that can be used are inter alia ethyl p-hydroxybenzoate, octyl p-hydroxybenzoate, N-n-butyltoluenesulfonamide, N-n-octyltoluenesulfonamide, N-n-butylbenzenesulfonamide, N-2-ethylhexylbenzenesulfonamide. A preferred plasticizer is N-n-butylbenzenesulfonamide.

Within the preferred range, the pelletized materials of the invention comprise from 0 to 15% by weight of plasticizer—based in each case on the polyamide.

Suitable sterically hindered phenols are in principle all of the compounds which have phenolic structure and which have at least one bulky group on the phenolic ring.

Examples of compounds that can preferably be used are those of the formula

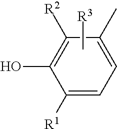

in which:
R¹ and R² are an alkyl group, a substituted alkyl group, or a substituted triazole group, where the radicals R¹ and R² can be identical or different, and R³ is an alkyl group, a substituted alkyl group, an alkoxy group, or a substituted amino group.

Antioxidants of the type mentioned are described by way of example in DE-A 27 02 661 (U.S. Pat. No. 4,360,617).

Another group of preferred sterically hindered phenols is those derived from substituted benzenecarboxylic acids, in particular from substituted benzenepropionic acids.

Particularly preferred compounds from this class are compounds of the formula

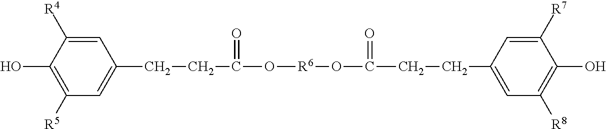

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to these formulae are

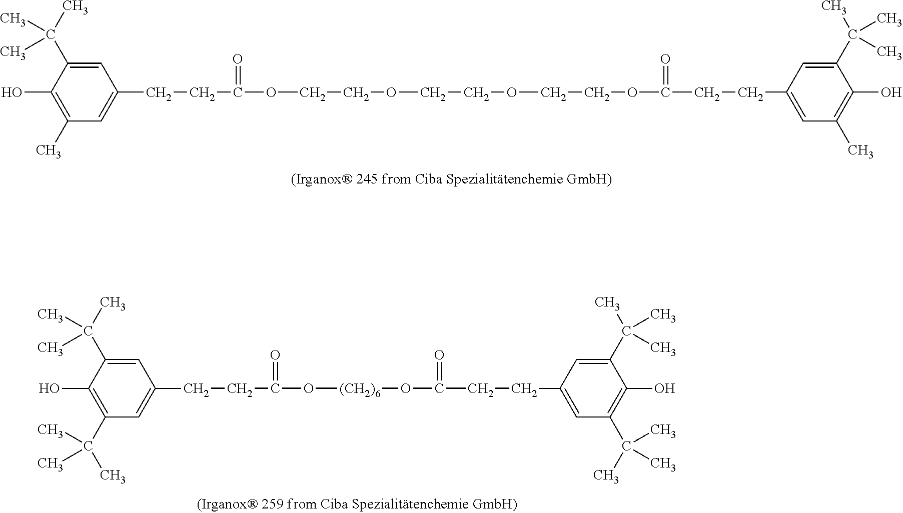

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxy-phenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydro-cinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxy-benzyl)benzene, 4,4′-methylenebis(2,6-di-tert-butylphenol), 3,5-di-tert-butyl-4-hydroxy-benzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylene-bis-3,5-di-tert-butyl-4-hydroxyhydrocinnamide (Irganox® 1098), and the product Irganox® 245 described above from Ciba Spezialitätenchemie GmbH, which has particularly good suitability.

The material optionally comprises amounts of from 0.05 to 3% by weight, preferably from 0.1 to 1.5% by weight, in particular from 0.1 to 1% by weight, based on the total weight of the components A) to C), of the phenolic antioxidants, which may be used individually or in the form of a mixture.

In some instances, compounds that are particularly advantageous are sterically hindered phenols having no more than one sterically hindered group in ortho-position relative to the phenolic hydroxy group.

Fibrous or particulate fillers C) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar, the amounts of these used being up to 30% by weight, in particular from 1 to 20% by weight.

Preferred fibrous fillers that may be mentioned are carbon fibers, aramid fibers, and potassium titanate fibers, and particular preference is given here to glass fibers in the form of E glass. These can be used in the form of rovings or chopped glass in the forms commercially available.

To improve compatibility with the pelletized polyamide, the fibrous fillers can have been surface-treated with silane compound.

Suitable silane compounds have the general formula

(X—(CH₂)ₙ)k-Si—(O—CₘH₂ₘ₊₁)₄₋ₖ

where:
X NH₂—,

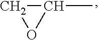

### HO—,

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight, and in particular from 0.05 to 0.5% by weight (based on the fibrous fillers).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, if appropriate, have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength. Other suitable fillers are carbon nanotubes, expandable graphite and other forms of graphite, and graphene and carbodinitride.

In particular, talc is used, and is a hydrated magnesium silicate with constitution Mg₃[(OH)₂/Si₄O₁₀] or 3 MgO.4 SiO₂.H₂O. These compounds known as three-layer phyllosilicates belong to the triclinic, monoclinic, or rhombic crystal systems with lamellar habit. Other trace elements that can be present are Mn, Ti, Cr, Ni, Na, and K, and fluoride can replace the OH group to some extent.

Examples of impact modifiers as component C) are rubbers, which can have functional groups. It is also possible to use a mixture of two or more different impact-modifying rubbers.

Rubbers which increase the toughness of the molding compositions generally comprise elastomeric content whose glass transition temperature is below −10° C., preferably below −30° C., and comprise at least one functional group capable of reaction with the polyamide. Examples of suitable functional groups are carboxylic acid, carboxylic anhydride, carboxylic ester, carboxamide, carboximide, amino, hydroxy, epoxy, urethane, or oxazoline groups, preferably carboxylic anhydride groups.

Among the preferred functionalized rubbers are functionalized polyolefin rubbers whose structure is composed of the following components:
1. from 40 to 99% by weight of at least one alpha-olefin having from 2 to 8 carbon atoms,
2. from 0 to 50% by weight of a diene,
3. from 0 to 45% by weight of a C₁-C₁₂-alkyl ester of acrylic acid or methacrylic acid, or a mixture of such esters,
4. from 0 to 40% by weight of an ethylenically unsaturated C₂-C₂₀ mono- or dicarboxylic acid or of a functional derivative of such an acid,
5. from 0 to 40% by weight of a monomer comprising epoxy groups, and
6. from 0 to 5% by weight of other monomers capable of free-radical polymerization,
   where the entirety of components 3) to 5) is at least from 1 to 45% by weight, based on components 1) to 6).

Examples that may be mentioned of suitable alpha-olefins are ethylene, propylene, 1-butylene, 1-pentylene, 1-hexylene, 1-heptylene, 1-octylene, 2-methylpropylene, 3-methyl-1-butylene, and 3-ethyl-1-butylene, preferably ethylene and propylene.

Examples that may be mentioned of suitable diene monomers are conjugated dienes having from 4 to 8 carbon atoms, such as isoprene and butadiene, non-conjugated dienes having from 5 to 25 carbon atoms, such as penta-1,4-diene, hexa-1,4-diene, hexa-1,5-diene, 2,5-dimethylhexa-1,5-diene, and octa-1,4-diene, cyclic dienes, such as cyclopentadiene, cyclohexadienes, cyclooctadienes, and dicyclopentadiene, and also alkenylnorbornene, such as 5-ethylidene-2-norbornene, 5-butylidene-2-norbornene, 2-methallyl-5-norbornene, 2-isopropenyl-5-norbornene, and tricyclodienes, such as 3-methyltricyclo[5.2.1.0^{2,6}]-3,8-decadiene, or a mixture of these. Preference is given to hexa-1,5-diene, 5-ethylidenenorbornene, and dicyclopentadiene.

The diene content is preferably from 0.5 to 50% by weight, in particular from 2 to 20% by weight, and particularly preferably from 3 to 15% by weight, based on the total weight of the olefin polymer. Examples of suitable esters are methyl, ethyl, propyl, n-butyl, isobutyl, and 2-ethylhexyl, octyl, and decyl acrylates and the corresponding methacrylates. Among these, particular preference is given to methyl, ethyl, propyl, n-butyl, and 2-ethylhexyl acrylate and the corresponding methacrylate.

Instead of the esters, or in addition to these, acid-functional and/or latent acid-functional monomers of ethylenically unsaturated mono- or dicarboxylic acids can also be present in the olefin polymers.

Examples of ethylenically unsaturated mono- or dicarboxylic acids are acrylic acid, methacrylic acid, tertiary alkyl esters of these acids, in particular tert-butyl acrylate, and dicarboxylic acids, e.g. maleic acid and fumaric acid, or derivatives of these acids, or else their monoesters.

Latent acid-functional monomers are compounds which, under the polymerization conditions or during incorporation of the olefin polymers into the molding compositions, form free acid groups. Examples that may be mentioned of these are anhydrides of dicarboxylic acids having from 2 to 20 carbon atoms, in particular maleic anhydride and tertiary C₁-C₁₂-alkyl esters of the abovementioned acids, in particular tert-butyl acrylate and tert-butyl methacrylate.

Examples of other monomers that can be used are vinyl esters and vinyl ethers.

Particular preference is given to olefin polymers composed of from 50 to 98.9% by weight, in particular from 60 to 94.85% by weight, of ethylene and from 1 to 50% by weight, in particular from 5 to 40% by weight, of an ester of acrylic or methacrylic acid, from 0.1 to 20.0% by weight, and in particular from 0.15 to 15% by weight, of glycidyl acrylate and/or glycidyl methacrylate, acrylic acid, and/or maleic anhydride.

Particularly suitable functionalized rubbers are ethylene-methyl methacrylate-glycidyl methacrylate polymers, ethylene-methyl acrylate-glycidyl methacrylate polymers, ethylene-methyl acrylate-glycidyl acrylate polymers, and ethylene-methyl methacrylate-glycidyl acrylate polymers.

The polymers described above can be prepared by processes known per se, preferably via random copolymerization at high pressure and elevated temperature.

The melt index of these copolymers is generally in the range from 1 to 80 g/10 min (measured at 190° C. with a load of 2.16 kg, to the standard ISO 1133).

Other rubbers that may be used are commercial ethylene-α-olefin copolymers which comprise groups reactive with polyamide. The underlying ethylene-α-olefin copolymers are prepared via transition-metal catalysis in the gas phase or in solution. The following α-olefins can be used as comonomers: propylene, 1-butene, 1-pentene, 4-methyl-1-pentene, 1-hexene, 1-heptene, 1-octene, 1-nonene, 1-decene, 1-undecene, 1-dodecene, styrene and substituted styrenes, vinyl esters, vinyl acetates, acrylic esters, methacrylic esters, glycidyl acrylates, glycidyl methacrylates, hydroxyethyl acrylates, acrylamides, acrylonitrile, allylamine and dienes, e.g. butadiene and isoprene.

Ethylene/1-octene copolymers, ethylene/1-butane copolymers, ethylene-propylene copolymers are particularly preferred, and compositions composed of
from 25 to 85% by weight, preferably from 35 to 80% by weight, of ethylene,
from 14.9 to 72% by weight, preferably from 19.8 to 63% by weight, of 1-octene or 1-butene, or propylene, or a mixture of these,
from 0.1 to 3% by weight, preferably from 0.2 to 2% by weight, of an ethylenically unsaturated mono- or dicarboxylic acid, or of a functional derivative of such an acid,
   are particularly preferred.

The molar mass of these ethylene-α-olefin copolymers is from 10 000 to 500 000 g/mol, preferably from 15 000 to 400 000 g/mol (Mn, determined by means of GPC in 1,2,4-trichlorobenzene using PS calibration).

The proportion of ethylene in the ethylene-α-olefin copolymers is from 5 to 97% by weight, preferably from 10 to 95% by weight, in particular from 15 to 93% by weight.

One particular embodiment prepared ethylene-α-olefin copolymers by using what are known as “single site catalysts”. Further details can be found in U.S. Pat. No. 5,272,236. In this case, the polydispersity of the ethylene-α-olefin copolymers is narrow for polyolefins: smaller than 4, preferably smaller than 3.5.

Another group of suitable rubbers that may be mentioned is provided by core-shell graft rubbers. These are graft rubbers which are prepared in emulsion and which are composed of at least one hard constituent and of at least one soft constituent. A hard constituent is usually a polymer whose glass transition temperature is at least 25° C., and a soft constituent is usually a polymer whose glass transition temperature is at most 0° C. These products have a structure composed of a core and of at least one shell, and the structure here results via the sequence of addition of the monomers. The soft constituents generally derive from butadiene, isoprene, alkyl acrylates, alkyl methacrylates, or siloxanes, and, if appropriate, from further comonomers. Suitable siloxane cores can, for example, be prepared starting from cyclic oligomeric octamethyltetrasiloxane or tetravinyltetramethyltetrasiloxane. By way of example, these can be reacted with gamma-mercaptopropylmethyldimethoxysilane in a ring-opening cationic polymerization reaction, preferably in the presence of sulfonic acids, to give the soft siloxane cores. The siloxanes can also be crosslinked, for example by carrying out the polymerization reaction in the presence of silanes having hydrolyzable groups, such as halogen or alkoxy groups, e.g. tetraethoxysilane, methyltrimethoxysilane, or phenyltrimethoxysilane. Suitable comonomers that may be mentioned here are, for example, styrene, acrylonitrile, and crosslinking or graft-active monomers having more than one polymerizable double bond, e.g. diallyl phthalate, divinylbenzene, butanediol diacrylate, or triallyl(iso)cyanurate. The hard constituents generally derive from styrene, and from alpha-methylstyrene, and from their copolymers, and preferred comonomers that may be listed here are acrylonitrile, methacrylonitrile, and methyl methacrylate.

Preferred core-shell graft rubbers comprise a soft core and a hard shell, or a hard core, a first soft shell, and at least one further hard shell. Functional groups, such as carbonyl, carboxylic acid, anhydride, amide, imide, carboxylic ester, amino, hydroxy, epoxy, oxazoline, urethane, urea, lactam, or halobenzyl groups, are preferably incorporated here via addition of suitably functionalized monomers during polymerization of the final shell. Examples of suitable functionalized monomers are maleic acid, maleic anhydride, mono- or diesters or maleic acid, tert-butyl (meth)acrylate, acrylic acid, glycidyl (meth)acrylate, and vinyloxazoline. The proportion of monomers having functional groups is generally from 0.1 to 25% by weight, preferably from 0.25 to 15% by weight, based on the total weight of the core-shell graft rubber. The ratio by weight of soft to hard constituents is generally from 1:9 to 9:1, preferably from 3:7 to 8:2.

Such rubbers are known per se and are described by way of example in EP-A-0 208 187. Oxazine groups for functionalization can be incorporated by way of example according to EP-A-0 791 606.

Another group of suitable impact modifiers is provided by thermoplastic polyester elastomers. Polyester elastomers here are segmented copolyetheresters which comprise long-chain segments which generally derive from poly(alkylene) ether glycols and comprise short-chain segments which derive from low-molecular-weight dials and from dicarboxylic acids. Such products are known per se and are described in the literature, e.g. in U.S. Pat. No. 3,651,014. Appropriate products are also commercially available as Hytrel™ (Du Pont), Amitel™ (Akzo), and Pelprene™ (Toyobo Co. Ltd.).

It is, of course, also possible to use a mixture of the types of rubber listed above.

The pelletized material of the invention can comprise, as further additives C), conventional processing aids, such as stabilizers, oxidation retarders, further agents to counter decomposition by heat and decomposition by ultraviolet light, lubricants and mold-release agents, colorants, such as dyes and pigments, nucleating agents, plasticizers, flame retardants, etc.

Examples that may be mentioned of oxidation retarders and heat stabilizers are phosphites and further amines (e.g. TAD), hydroquinones, various substituted representatives of these groups, and their mixtures, at concentrations of up to 1% by weight, based on the weight of the pelletized material.

UV stabilizers that may be mentioned, the amounts of which generally used are up to 2% by weight, based on the pelletized material, are various substituted resorcinols, salicylates, benzotriazoles, and benzophenones.

Colorants that may be added are inorganic pigments, such as titanium dioxide, ultramarine blue, iron oxide, and carbon black and/or graphite, and also organic pigments, such as phthalocyanines, quinacridones, perylenes, and also dyes, such as nigrosin and anthraquinones.

Nucleating agents that can be used are sodium phenylphosphinate, aluminum oxide, silicon dioxide, and also preferably talc.

Flame retardants that may be mentioned are red phosphorus, P- and N-containing flame retardants, and also halogenated flame-retardant systems and synergists of these. Preference is given to melamine, melamine cyanurates, Al phosphinate (e.g. Exolit OP, Clariant), 1,2-bis(pentabromophenyl)methane (e.g. Saytex® 8010, Albemarle Corp.), and, as synergist, Fyreblock 1411.

Pelletized materials of the invention exhibit very good shelf life, the polymer can even be used after more than eight months, to give a foam with density the same as that obtained directly after production of the expandable pelletized polymer material (polymer).

The foams obtained feature a particular property profile that is novel for moldable foams:
very low heat-shrinkage: <1% shrinkage in 1 h at 160° C.
passing the B2 fire test (laboratory apparatus) for densities around 100 g/L without flame retardant, to DIN 4102
high solvent resistance
good adhesion and stability when epoxy adhesives are used, and
good metal adhesion.

The pelletized materials and moldable foams of the invention are suitable for use by way of example in motor-vehicle construction, in the airline industry, in the transport sector, in the packing industry, or for insulation that resists temperature changes, e.g. in the construction sector, or in construction engineering, or in the packaging industry, and as insulation material.

The examples provide further explanation of the invention but do not restrict the same.

### EXAMPLES

### Example 1

### Production

40 parts of nylon-6 (Ultramid B36, BASF SE, Ludwigshafen) and 60 parts of nylon-6,I (Grivory G16, EMS-Chemie, Gross-Umstadt) were mixed by a melt-impregnation process with 1.5 parts of water and one part of isopentane and also one part of talc (IT Extra, Mondo Mineralis, Amsterdam).

Prior to processing, all of the polymers were dried in vacuo for at least 4 h at 80° C., The polyamides, and also the other components, such as batches comprising flame retardant and talc, were charged without heating to an extruder having corotating screws (Leistritz, screw diameter 18 mm, screw length 40 D). The extruder was operated with a screw speed of 100 revolutions/minute. By virtue of the structure of the screw, all of the polymers were melted, and other additions were homogeneously incorporated into the melt. Along the length of the screw, the physical blowing agents, such as isopentane, and also water, were added to the extruder and mixed with the melt or dissolved therein. Total was 3 kg/h.

The entire mixture was pressurized by way of an ingoing-pressure-controlled gear pump installed at the extruder outlet, in order to proceed past a bypass valve and a discharge die to the pelletization process for the material (die diameter 0.75 mm, one die aperture, die temperature about 280° C.). The temperature of the melt prior to pelletization was dependent on the material used and was from 200 to 240° C. The material was pelletized under the pressure generated by water (15 bar) at relatively low water temperatures (about 42° C.), in order to avoid premature foaming. The resultant pressure of the melt at the discharge die depended on the material used and was from 140 to 300 bar. The average particle size obtained for the expandable pelletized material was about 1.25 mm.

The extrusion and underwater pelletization process gave a semicrystalline matrix polymer.

The average diameter of the expandable particles was 1.25 mm.

The melting point of the polymer matrix was 210° C. and its glass transition temperature was 83° C., with 5% crystallinity. Crystallinity was determined in the invention with the aid of dynamic differential calorimetry (DSC, differential scanning calorimetry) via integration of the melting signal, i.e. 100% crystallinity corresponds to 230 J/g (Journal of Polymer Science Part B Polymer Physics 35 (1997) 2219-2231). The measurement in the invention is made in accordance with ISO 11357-7. Melting point was determined in the invention to ISO 11357-3, using heating and cooling rates of 20 K/min. Glass transition temperature was determined in the invention to ISO 11357-2, using heating and cooling rates of 20 K/min.

### Processing and Properties

The pelletized material obtained was expanded in a prefoamer (PREEX-1000 from Hirsch) at 104° C. and a gauge pressure of 0 bar in 20 and, respectively, 60 sec to give foam beads with bulk densities of 90 g/L and, respectively, 140 g/l. After overnight storage at room temperature, the foam beads were compressed in an automatic molding machine at a gauge pressure of 2.4 bar to give slabs measuring about 20 cm×30 cm×5 cm. The molded foams obtained after drying of the slabs at an elevated temperature (from 60 to 80° C.) for from 16 to 36 h were dry, exhibited very good fusion, and had densities of 92 g/L and, respectively, 141 g/L.

The heat-shrinkage of the resultant molded foam was smaller than 1% at 160° C. in 1 h. This was measured by trimming the molded foam to give a cube of edge length 50.0 mm and storing this for one hour at 160° C. in a convection oven.

### Example 2

### Production

39 parts of nylon-6 (Ultramid B36, BASF SE, Ludwigshafen), 2.5 parts of polystyrene (158K, BASF SE, Ludwigshafen) and 58.5 parts of nylon-6,I (Grivory G16 EMS-Chemie, Gross-Umstadt) were mixed by a melt-impregnation process with two parts of water and with two parts of isopentane and also one part of talc (IT Extra, Mondo Mineralis, Amsterdam).

Prior to processing, all of the polymers were dried in vacuo for at least 4 h at 80° C. The polyamides, and also the other components, such as batches comprising flame retardant and talc, were charged without heating to an extruder having corotating screws (Leistritz, screw diameter 18 mm, screw length 40 D). The extruder was operated with a screw speed of 100 revolutions/minute. By virtue of the structure of the screw, all of the polymers were melted, and other additions were homogeneously incorporated into the melt. Along the length of the screw, the physical blowing agents, such as isopentane, and also water, were added to the extruder and mixed with the melt or dissolved therein. Total was 3 kg/h.

The entire mixture was pressurized by way of an ingoing-pressure-controlled gear pump installed at the extruder outlet, in order to proceed past a bypass valve and a discharge die to the pelletization process for the material (die diameter 0.75 mm, one die aperture, die temperature about 280° C.). The temperature of the melt prior to pelletization was dependent on the material used and was from 200 to 240° C. The material was pelletized under the pressure generated by water (15 bar) at relatively low water temperatures (about 42° C.), in order to avoid premature foaming. The resultant pressure of the melt at the discharge die depended on the material used and was from 140 to 300 bar. The average particle size obtained for the expandable pelletized material was about 1.25 mm.

The extrusion and underwater pelletization process gave a semicrystalline matrix polymer. The average diameter of the expandable particles was 1.25 mm. The melting point of the polymer matrix was 213° C. and its glass transition temperature was 95° C., with 8% crystallinity. Crystallinity was determined in the invention with the aid of dynamic differential calorimetry (DSC, differential scanning calorimetry) via integration of the melting signal, i.e. 100% crystallinity corresponds to 230 J/g (Journal of Polymer Science Part B Polymer Physics 35 (1997) 2219-2231). The measurement in the invention is made in accordance with ISO 11357-7. Melting point was determined in the invention to ISO 11357-3, using heating and cooling rates of 20 K/min. Glass transition temperature was determined in the invention to ISO 11357-2, using heating and cooling rates of 20 K/min.

### Processing and Properties

This expandable pelletized material was expanded in a prefoamer (PREEX-1000 from Hirsch) at 104° C. and a gauge pressure of 0 bar in 20 and, respectively, 60 sec to give foam beads with bulk densities of 70 g/l and, respectively, 120 g/l. After overnight storage at room temperature, the foam beads were compressed in an automatic molding machine at a gauge pressure of 2.4 bar to give slabs measuring about 20 cm×30 cm×5 cm. The molded foams obtained after drying of the slabs at an elevated temperature (from 60 to 80° C.) for from 16 to 36 h were dry, exhibited very good fusion, and had densities of 72 g/l and, respectively, 124 g/l.

### Example 3

Expandable Pelletized Material with Flame Retardants

### Production

Production of the expandable pelletized material and of the foam products was analogous to that in example 1. The stated amounts of flame-retardant additives were also added (described as further additives). The results are shown in Table 1.

Foam slabs measuring 6.5 cm×6.5 cm×1 cm were analogously subjected to flame in the procedure described in DIN 4102, and the foam was tested for self-extinguishing capability.

### List of Substances

| Name of | | |
|---|---|---|
| substance | Producer | Chemical constitution |
| Ultramid B36 | BASF SE, | PA6 |
| | Ludwigshafen | |
| Grivory G16 | EMS Chemie, Gross- | PA 6I/6T |
| | Umstadt | |
| Talkum IT | Mondomineralis, | Talc |
| extra | Amsterdam | |
| Budit 315 | ® Budenheim KG, | Melamine cyanurate |
| | Budenheim | |
| Saytex 8010 | Albemarle | Bis(pentabromophenyl)methane |
| | Corporation, Belgium | |
| Fyrebloc 1411 | Chemtura Corporation, | Antimon trioxide, polyamide |
| | USA | |
| Exolit OP1312 | Clariant, Switzerland | Al phosphinate |

TABLE 1
Amounts of flame retardants and results of fire tests

| | | Flame | | | | |
|---|---|---|---|---|---|---|
| | | retardant | | Synergist | Foam | |
| | Flame | (propor- | | (propor- | density | |
| Example | retardant | tion) | Synergist | tion) | in g/L | Fire result |
| Compara- | — | — | — | — | 85 | Burns |
| tive | | | | | | |
| example 1 | | | | | | |
| 3.1 | Budit 315 | 0.50 | — | — | 108 | self- |
| | | | | | | extinguishing |
| 3.2 | Budit 315 | 1.00 | — | — | 85 | self- |
| | | | | | | extinguishing |
| 3.3 | Saytex 8010 | 0.25 | Fyrebloc | 0.25 | 69 | self- |
| | | | 1411, | | | extinguishing |
| | | | Chemtura | | | |
| | | | corporation | | | |
| 3.4 | Saytex 8010 | 0.50 | Fyrebloc | 0.50 | 75 | self- |
| | | | 1411 | | | extinguishing |
| 3.5 | Saytex 8010, | 1.00 | Fyrebloc | 1.00 | 86 | self- |
| | Albemarle | | 1411, | | | extinguishing |
| | | | Chemtura | | | |
| | | | corporation | | | |
| 3.6 | Saytex 8010, | 2.50 | Fyrebloc | 2.50 | 102 | self- |
| | Albemarle | | 1411, | | | extinguishing |
| | | | Chemtura | | | |
| | | | corporation | | | |
| 3.7 | Exolit | 1.00 | — | — | 68 | self- |
| | OP1312, | | | | | extinguishing |
| | Clariant | | | | | |
| 3.8 | Exolit | 3.00 | — | — | 69 | self- |
| | OP1312, | | | | | extinguishing |
| | Clariant | | | | | |
| 3.9 | Fyrebloc1411 | 1.25 | — | — | 60 | Self- |
| | Chemtura | | | | | extinguishing |
| | corporation | | | | | |

The examples confirm that the pelletized materials obtained have good flame-retardant properties.

### Example 4

Expandable Pelletized Material with Different Admixtures

### Production

Production of the expandable pelletized material and of the foams was analogous to that in example 1. The stated amounts of admixtures were also added. The results are shown in Table 2.

### List of Substances

| Name of substance | Producer | Chemical constitution |
|---|---|---|
| Ultramid B36 | BASF SE, | PA6 |
| | Ludwigshafen | |
| Grivory G16 | EMS Chemie, Gross- | PA 6I/6T |
| | Umstadt | |
| | BASF SE | PA 6T/66/6 |
| Talkum IT extra | Mondomineralis, | Talc |
| | Amsterdam | |
| Jandryl ADR 4368 | BASF SE | Chain extender |
| VT2410 | BASF SE | Styrene-acrylonitril-maleic |
| | | acid anhydride-terpolymer |
| Kraton G 1910 | Kraton Polymers | SEBS-aleic acid anhydride- |
| | | copolymer |
| PS 158 K | BASF SE | polystyrene |

TABLE 2
Expandable pelletized material with different admixtures.

| | | Thermoplastic | | | | | | | | | |
|---|---|---|---|---|---|---|---|---|---|---|---|
| Examples | | polymers A2) | 4.1 | 4.2 | 4.3 | 4.4 | 4.5 | 4.6 | 4.7 | 4.8 | 4.9 |
| A1) | Polyamides | | | | | | | | | | |
| | PA6i | Grivory G 16 | 60 | 60 | 60 | 48 | 48 | 60 | 40 | 54 | 60 |
| | PA 6 | Ultramid B36 | 40 | 40 | 40 | 32 | 32 | | | 36 | 40 |
| | PA6T/66/6 | | | | | | | 40 | 60 | | |
| A2) | Thermoplastic | | | | | | | | | | |
| | polymers | | | | | | | | | | |
| | SANMA | VT 2410 | | | | 20 | | | | | |
| | SEBS-MA | Kraton G1910 | | | | | 20 | | | | |
| | PS | PS158K | | | | | | | | 10 | |
| B) | Blowing agent | | | | | | | | | | |
| | iso-Pentan | | 1.3 | 1.6 | 1.6 | 2.5 | 4.0 | 1.6 | 1.6 | 2.0 | 1.6 |
| | (dosed) | | | | | | | | | | |
| | Water | | 2 | 2 | | 2 | 2 | 2 | 2 | 2 | 2 |
| | Ethanol | | | | 2 | | | | | | |
| C) | Additives | | | | | | | | | | |
| | Talcum | IT Extra | 1.0 | 1.0 | 1.0 | 1.0 | 1.0 | 1.0 | 1.0 | 1.0 | 1.0 |
| | Stabilizer | | | 1.0 | | | | | | | |
| | CuI/KI | | | | | | | | | | |
| | Chain extender | Joncryl ADR4368 | | | | | | | | | 0.6 |

| | | | | | | | | | |
|---|---|---|---|---|---|---|---|---|---|
| Expandable bead density (g/L) | 610 | 609 | 495 | 609 | 435 | 460 | 459 | 585 | 601 |
| Pre-foaming temerature (° C.) | 100 | 100 | 100 | 100 | 100 | 100 | 100 | 100 | 100 |
| Pre-foaming time (s). | 60 | 60 | 60 | 60 | 60 | 60 | 60 | 60 | 60 |
| Foam density after pre-expansion (g/L) | 60 | 83 | 115 | 83 | 208 | 65 | 92 | 158 | 72 |

Examples 4.1 to 4.9 demonstrate that foams with predominantly low densities are obtained also with different added polymers, additives and co-blowing agents.

1. An expandable pelletized material comprising
A) a polymer matrix composed of
A1) at least 55% by weight of polyamide (based on the entirety of components A1) and A2)) with a crystallinity of up to 30% and optionally a melting point in the range from 100 to 340° C. and a glass transition temperature in the range from 0 to 150° C., and
A2) from 0 to 45% by weight of one or more thermoplastic polymers that differ from component A1);
B) a physical blowing agent composition, and
C) optionally further additives.

2. The expandable pelletized material according to claim 1, where the crystallinity is in the range from 1 to 25%.

3. The expandable pelletized material according to claim 1, where the glass transition temperature is in the range from 15 to 130° C.

4. The expandable pelletized material according to claim 1, where, in the case of semicrystalline polymers, the melting point is in the range from 100 to 340° C.

5. The expandable pelletized material according to claim 1, where the polymer matrix A) is composed of polyamide component A1).

6. The expandable pelletized material according to claim 1, where the polymer matrix A) comprises, based on the entirety of components A1) and A2), from 0.1 to 4.9% by weight of one or more thermoplastic polymers A2).

7. The expandable pelletized material according to claim 6, comprising, as component A2), one or more styrene polymers and/or their blends with one or more polyphenylene ethers.

8. The expandable pelletized material according to claim 1, where component A1) comprises two or more polyamides from the group of polycaprolactam (PA6), polybutyleneadipamide (PA 46), polyhexamethyleneadipamide (PA 66), polyhexamethylenesebacamide (PA 610), polyhexamethylenedodecanamide (PA 612), poly-11-aminoundecanamide (PA 11), polylaurolactam (PA 12), poly-m-xylyleneadipamide (PAMXD 6), polypentamethylenesebacamide (PA 510), 6T/X (X=lactam), 6T/6I, 6T/6I/XY, 6T/XT (X=straight-chain or branched C₄-C₁₈-diamine), XT (X C₄-C₁₈-diamine), 6.12. PA PACM 12 (PACM=p-diaminodicyclohexylmethane), PA MACM 12 (MACM=3,3-dimethyl-p-diaminodicyclohexylmethane), PA MPMD 6 (MPMD=2-methylpentamethylenediamine), PA MPMD T, PA MPMD 12, polyhexamethyleneisophthalamide (PA 6I), PA 6I/6T, PA 6-3-T (polyamide made of terephthalic acid, mixtures made of 2,2,4- and 2,4,4-trimethylhexamethylenediamine) and their transamidation products.

9. The expandable pelletized material according to claim 8, where component A1) comprises PA6, PA 6/66 and/or PA 610 in a mixture with PA 6I, and/or comprises their transamidation products.

10. The expandable pelletized material according to claim 1, comprising, as blowing agent component B), one or more physical blowing agents.

11. The expandable pelletized material according to claim 10, comprising, based on the entirety of components A) and B), from 0.01 to 7% by weight of one or more physical organic blowing agents.

12. The expandable pelletized material according to claim 1, comprising (based on the weight of the polymer matrix A)) from 0.1 to 10% by weight of H₂O.

13. The expandable pelletized material according to claim 1, comprising, as additives C) (based on the entirety of components A), B), and C)), from 0.1 to 40% by weight of one or more compounds from the group of the stabilizers, oxidation retarders, agents that counteract decomposition due to heat and decomposition due to ultraviolet light, lubricants and mold-release agents, dyes, pigments, nucleating agents, plasticizers, flame retardants, and fillers.

14. The pelletized material according to claim 13, comprising one or more flame retardants from the group of red phosphorus, P- and N-containing flame retardants, melamine, melamine cyanurates, halogenated flame retardant systems, and their synergists.

15. A process comprising the following steps for producing an expandable pelletized material according to claim 1:
a) providing the polyamide A1) and optionally of polymer component A2) in a molten state,
b) mixing to incorporate physical blowing agent component B) and optionally one or more additives C) into the melt,
c) extrusion, and
d) underwater pelletization of the melt comprising blowing agent.

16. The expandable pelletized material according to claim 1, obtainable via
a) providing a mixture comprising two or more polyamides from the group of polycaprolactam (PA6), polybutyleneadipamide (PA 46), polyhexamethyleneadipamide (PA 66), polyhexamethylenesebacamide (PA 610), polyhexamethylenedodecanamide (PA 612), poly-11-aminoundecanamide (PA 11), polylaurolactam (PA 12), poly-m-xylyleneadipamide (PAMXD 6), polypentamethylenesebacamide (PA 510), 6T/X (X=lactam), 6T/6I, 6T/6I/XY, 6T/XT (X=straight-chain or branched C₄-C₁₈-diamine), XT (X=C₄-C₁₈-diamine), 6.12. PA PACM 12 (PACM=p-diaminodicyclohexylmethane), PA MACM 12 (MACM=3,3-dimethyl-p-diaminodicyclohexylmethane), PA MPMD 6 (MPMD=2-methylpentamethylenediamine), PA MPMD T, PA MPMD 12, polyhexamethyleneisophthalamide (PA 61), PA 6I/6T, PA 6-3-T (polyamide made of terephthalic acid, mixtures made of 2,2,4- and 2,4,4-trimethylhexamethylenediamine) and their transamidation products,
b) mixing to incorporate physical blowing agent component B) and if appropriate one or more additives C) into the melt,
c) extrusion, and
d) underwater pelletization of the melt comprising blowing agent.

17. A moldable polyamide foam, obtainable by prefoaming of an expandable pelletized material according to claim 1.

18. The moldable foam according to claim 17 with a density in the range from 25 to 300 g/l.

19. A foam molding obtainable by expansion and compression of the moldable polyamide foam according to claim 18.

20. A material for application in the automobile industry, airline industry, construction industry, packaging industry, or sports and leisure industry, or in the transport sector, and/or in engineering, comprising a moldable polyamide foam according to claim 18.
